(19) United States
(12) Patent Application Publication
(10) Pub. No.: US 2025/0051593 A1
(43) Pub. Date: Feb. 13, 2025

(54) ANTI-CORROSIVE COATING AND PREPARATION METHOD THEREFOR

(71) Applicant: FUJIAN INSTITUTE OF RESEARCH ON THE STRUCTURE OF MATTER , CHINESE ACADEMY OF SCIENCES, Fuzhou, Fujian (CN)

(72) Inventors: Longhui ZHENG, Fuzhou, Fujian (CN); Huang LIN, Fuzhou, Fujian (CN); Zixiang WENG, Fuzhou, Fujian (CN); Jianlei WANG, Fuzhou, Fujian (CN); Lixin WU, Fuzhou, Fujian (CN)

(21) Appl. No.: 18/851,419

(22) PCT Filed: Dec. 14, 2023
(86) PCT No.: PCT/CN2023/138734

§ 371 Date: Sep. 26, 2024

(30) Foreign Application Priority Data
Dec. 26, 2022 (CN) 202211686924.2

(51) Int. Cl. C09D 7/62; C09D 5/08; C09D 7/40; C09D 163/00

(52) U.S. Cl. CPC C09D 7/62; C09D 5/08; C09D 7/70; C09D 163/00

(57) ABSTRACT

An anti-corrosive coating and a preparation method therefor are provided. The method includes the following steps: (1) dispersing graphite and a modifier in water to prepare a pretreated graphite dispersion; (2) stripping and modifying the pretreated graphite dispersion obtained in step (1) to prepare a modified graphene dispersion; and (3a) mixing the modified graphene dispersion obtained in the step (2) with epoxy resin and a cationic photoinitiator, standing, carry out phase splitting, removing a water phase, further deeply removing water to obtain a graphene/epoxy resin mixture, and curing the obtained mixture to obtain the anti-corrosive coating. By means of a phase transfer method, the application of a modified graphene aqueous dispersion in resin can be realized without drying graphene first, so that uniform dispersion of modified graphene in epoxy resin can be ensured, and additionally, stacking of the modified graphene in the drying process can be avoided.

The present application claims priority to the prior application with the patent application No. 2022116869242 and entitled “ANTI-CORROSIVE COATING AND PREPARATION METHOD THEREFOR” filed with the China National Intellectual Property Administration on Dec. 26, 2022, which is incorporated herein by reference in its entirety.

### TECHNICAL FIELD

The present disclosure relates to the field of coatings, and in particular to an anti-corrosive coating and a preparation method therefor.

### BACKGROUND

Metal materials are often corroded in industrial production, and severe corrosion can cause the deterioration of material properties, thereby shortening the service life of equipment. Therefore, it is necessary to take measures to prevent corrosion of metal materials and to ensure their safe and effective use in corrosive environments. Among these measures, epoxy coatings are considered as a simple and effective corrosion protection strategy due to their economical utility, excellent mechanical properties, and high adhesion to metal substrates. However, in long-term use, long-lasting anti-permeation protection cannot be provided due to the limitation of the cured network structure of the epoxy coatings.

Graphene is a two-dimensional carbon nanomaterial with excellent chemical inertness and impermeability, which can effectively prevent corrosion by corrosive media such as oxygen, water, and chloride ions. By adding a small amount of graphene to the epoxy coatings, the “masking effect” of graphene can be effectively utilized to extend permeation paths of the corrosive media in the cured network, so that a “labyrinth effect” is formed, and thus the corrosion by the corrosive media is hindered. Therefore, improving the dispersion and ordered arrangement of graphene in the coatings is crucial to effectively exert a “masking effect” of graphene.

In order to improve the dispersibility of graphene in the coating matrix, researchers have tried to use various preparation methods and modification means to make the surface of graphene carry hydrophilic groups or organophilic groups, so that graphene has better dispersibility in the coating matrix. The covalent bond modification method is one of the existing mature graphene modification methods, and is characterized in that a target group is grafted through a covalent interaction by taking advantage of high reactivity at a defect site of graphene. However, the original structure of graphene is damaged by a covalent bond modification, and some inherent properties of graphene are deteriorated. Meanwhile, some modifiers have disadvantages such as high toxicity and easy pollution. In contrast, the non-covalent bond modification method is characterized in that functional groups can be provided for graphene without damaging the surface structure of graphene through interactions such as π-π stacking, ionic bonding, hydrogen bonding, and electrostatic force. The non-covalent bond modification has a simple process and mild reaction conditions, and thus is a green, environment-friendly, and efficient modification means. Among these interactions, the π-π stacking interaction is the most common and effective way for a non-covalent modification of graphene.

However, most of the existing preparation methods and modification means for graphene are relatively complex and have cumbersome and complicated process steps, including preparation steps such as pretreatment, long-time preparation, and modification. Moreover, most studies are based on graphene oxide prepared by Hummers method. The Hummers method is difficult to operate, and there is even a risk of explosion if it is not operated properly, and at the same time, the method requires the use of strong acids and strong oxidants, which will cause serious environmental pollution and generate a large amount of wastewater in the treatment process. Therefore, there is a need to seek a simple, fast, environment-friendly, safe, and economical preparation method for graphene.

For graphene anti-corrosive coatings, graphene aqueous solutions are obviously more environment-friendly and more acceptable than graphene organic solvents, but there are obvious limitations to the application of graphene aqueous solutions in oleoresin. In addition, the ordered arrangement of graphene in the matrix is more favorable for extending the permeation paths than the random arrangement. Researchers have prepared graphene coatings with parallel orientations by various means, including a magnetic field orientation, an electric field orientation, a self-assembly orientation, and the like. However, most of these methods have certain limitations, requiring specific particles or polymers (such as Fe₃O₄ and polydopamine) to be loaded on graphene to induce the orientation. Therefore, how to prepare oriented graphene rich in functional groups is the key for realizing high-efficiency and long-lasting corrosion prevention of coatings.

### SUMMARY

In order to improve the above technical problems, the present disclosure provides an anti-corrosive coating and a preparation method therefor. According to the method, graphite is used as a starting material, a modifier calcein is added to water, the graphite is stripped under the action of a microfluidizer at an ultrahigh shearing rate to prepare a modified graphene aqueous solution, the modified graphene is dispersed in resin through a phase transfer method, and then orientation is induced by centrifugal force, so that the anti-corrosive coating is prepared. The method has a green preparation process, excellent product properties, and very broad application prospects.

The present disclosure provides the following technical solutions:

A preparation method for an anti-corrosive coating, comprising the following steps:
(1) dispersing graphite and a modifier in water to prepare a pretreated graphite dispersion;
(2) subjecting the pretreated graphite dispersion obtained in step (1) to stripping and modification to prepare a modified graphene dispersion;
(3a) mixing the modified graphene dispersion obtained in step (2) with epoxy resin and a cationic photoinitiator, standing, performing phase separation, removing an aqueous phase, further deeply removing water to obtain a graphene/epoxy resin mixture, and curing the obtained mixture to prepare the anti-corrosive coating.

According to an embodiment of the present disclosure, the anti-corrosive coating can also be prepared by coating a support with the mixture. The type of the support is not particularly limited, so long as the coating can be formed.

According to an embodiment of the present disclosure, the method comprises step (3b): mixing the modified graphene dispersion obtained in step (2) with epoxy resin and a cationic photoinitiator, coating the surface of a metal material with the obtained mixture, standing, performing phase separation, removing an aqueous phase, further deeply removing water to obtain a graphene/epoxy resin mixture, and performing curing to prepare the anti-corrosive coating.

According to an embodiment of the present disclosure, the method comprises step (3c): mixing the modified graphene dispersion obtained in step (2) with epoxy resin and a cationic photoinitiator, standing, performing phase separation, removing an aqueous phase, further deeply removing water to obtain a graphene/epoxy resin mixture, coating the surface of a metal material with an epoxy resin layer, then coating the surface of the epoxy resin layer with the mixture, and performing curing to prepare the anti-corrosive coating.

According to an embodiment of the present disclosure, in step (1), the modifier is calcein; the calcein has a structural formula shown as follows:

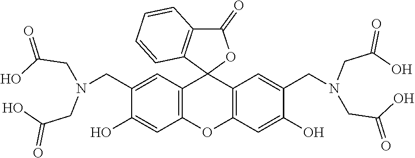 [SMILES: O=C(O)CN(CC(=O)O)Cc1cc2c(cc1O)Oc1cc(O)c(CN(CC(=O)O)CC(=O)O)cc1C21OC(=O)c2ccccc21]

According to an embodiment of the present disclosure, in step (1), the modifier is at a concentration of 1-20 mg/mL, e.g., 5-14 mg/mL, 10-20 mg/mL, or 1-12 mg/mL, exemplarily 1 mg/mL, 2 mg/mL, 4 mg/mL, 5 mg/mL, 6 mg/mL, 8 mg/mL, 10 mg/mL, 12 mg/mL, 14 mg/mL, 15 mg/mL, 16 mg/mL, 18 mg/mL, or 20 mg/mL.

According to an embodiment of the present disclosure, in step (1), a starting material of the graphite may be selected from at least one of natural flake graphite, expanded graphite, graphite powder, and the like. Further, the graphite is in the form of powder, for example, the graphite powder has a mesh size of 80-5000 meshes.

According to an embodiment of the present disclosure, in step (1), graphite in the pretreated graphite dispersion is at a concentration of 1-60 mg/mL, e.g., 3-17 mg/mL or 15-40 mg/mL, exemplarily 1 mg/mL, 3 mg/mL, 5 mg/mL, 6 mg/mL, 8 mg/mL, 10 mg/mL, 12 mg/mL, 14 mg/mL, 15 mg/mL, 17 mg/mL, 18 mg/mL, 20 mg/mL, 30 mg/mL, 35 mg/mL, 40 mg/mL, 50 mg/mL, or 60 mg/mL.

According to an embodiment of the present disclosure, in step (1), the dispersion may be dispersion by shearing using a high-shear dispersing emulsifier, ultrasonic dispersion, or dispersion by stirring.

According to an embodiment of the present disclosure, in step (1), the dispersion is performed for, e.g., 1-100 min.

According to an embodiment of the present disclosure, step (1) may specifically be: (la) adding graphite to water, adding a modifier, and then dispersing the mixture by shearing using a high-shear dispersing emulsifier to obtain a pretreated graphite dispersion.

According to an embodiment of the present disclosure, step (1) may also be: (1b) adding graphite to water, adding a modifier, and then performing ultrasonic treatment to obtain a pretreated graphite dispersion.

According to an embodiment of the present disclosure, step (1) may also be: (1c) adding graphite to water, adding a modifier, and then stirring the mixture to obtain a pretreated graphite dispersion.

According to an embodiment of the present disclosure, in step (la), the dispersion is performed for 1-100 min, e.g., 15-50 min, exemplarily 15 min, 30 min, 50 min, or 100 min; the high-shear dispersing emulsifier is at a rotation speed of 100-15,000 rpm, e.g., 500-10,000 rpm, exemplarily 1000 rpm, 2500 rpm, or 5000 rpm.

According to an embodiment of the present disclosure, in step (1b), the ultrasonic treatment is performed for 1-10 min; the ultrasonication is under the power of 80-200 W.

According to an embodiment of the present disclosure, in step (2), the stripping and modification are performed by using a microfluidizer.

It should be noted that the “subjecting the pretreated graphite dispersion to stripping and modification” in step (2) means that the stripping and modification are simultaneously performed on the graphite dispersion in one step, so that the graphite is stripped to obtain graphene, and the graphene is modified to obtain a modified graphene dispersion.

According to an embodiment of the present disclosure, step (2) is specifically: adding the pretreated graphite dispersion to a microfluidizer for stripping and modification to obtain a modified graphene dispersion.

According to an embodiment of the present disclosure, in step (2), the stripping and modification process of the pretreated graphite dispersion in the microfluidizer comprises: circulating the pretreated graphite dispersion for 10-30 times (exemplarily 10 times, 15 times, 20 times, or 30 times) through a 150-400 μm (exemplarily 150 μm, 200 μm, 250 μm, 300 μm, or 400 μm) nozzle at a pressure of 3000-10,000 psi (exemplarily 3000 psi, 6000 psi, or 10,000 psi).

According to an embodiment of the present disclosure, the epoxy resin is one of bisphenol A epoxy resin, hydrogenated bisphenol A epoxy resin, bisphenol F epoxy resin, bisphenol S epoxy resin, glycidyl ether epoxy resin, cycloaliphatic epoxy resin, silicone-modified epoxy resin, and polyurethane epoxy resin, exemplarily bisphenol A epoxy resin or hydrogenated bisphenol A epoxy resin.

According to an embodiment of the present disclosure, the cationic photoinitiator is one of an aryldiazonium salt, a diaryliodonium salt, a triarylsulfonium salt, and an arylferrocenium salt, exemplarily diphenyl(4-(phenylthio)phenyl)sulfonium hexafluoroantimonate (CAS number: 71449-78-0).

According to an embodiment of the present disclosure, the epoxy resin and the cationic photoinitiator are in a mass ratio of 10-50:1, preferably 15-30:1.

According to an embodiment of the present disclosure, modified graphene in the modified graphene dispersion has a mass of 0.1%-2%, preferably 0.3%-1%, of the total mass of the epoxy resin and the cationic photoinitiator.

According to an embodiment of the present disclosure, in step (3a), (3b), or (3c), curing may also be performed after removing water from the mixture. For example, at least one of standing and phase separation, rotary evaporation, and molecular sieve drying may be adopted.

Exemplarily, when removing water by rotary evaporation, the spin coater has a speed of 1000-5000 rpm.

According to an embodiment of the present disclosure, in step (3c), the metal material is one of iron, aluminum, copper, zinc, steel, and alloy, exemplarily iron sheet or steel sheet.

According to an embodiment of the present disclosure, the curing is UV curing, and the curing is performed for 50-300 s, exemplarily 50 s, 100 s, 120 s, 150 s, 200 s, 250 s, or 300 s. The present disclosure further provides an anti-corrosive coating prepared by the method described above.

According to an embodiment of the present disclosure, the anti-corrosive coating has an impedance modulus of 1.0×10¹¹ Ω·cm²-8.5×10¹² Ω·cm² after being soaked in a 3.5 wt % NaCl solution for 55 days.

### Beneficial Effects of Present Disclosure

(1) According to the present disclosure, graphite is used as a starting material, water is used as a dispersion medium, calcein is used as a stripping adjuvant and a modifier, and a microfluidizer is used for preparing modified graphene, so that no organic solvent is contained in the starting material for the preparation and the process is safe.

(2) The modified graphene dispersion of the present disclosure contains active groups such as hydroxyl and carboxyl, so that not only can the dispersion be well dispersed in epoxy resin, but also the dispersion can form a better interface interaction with the epoxy resin.

(3) The modified graphene dispersion adopted by the present disclosure is electronegative, the cationic initiator is adopted, and by a phase transfer method, the application of the modified graphene dispersion in resin can be realized without drying graphene first, so that uniform dispersion of the modified graphene in epoxy resin can be ensured, and meanwhile, stacking of the modified graphene in the drying process can be avoided, thereby better exerting excellent properties of the modified graphene.

(4) According to the present disclosure, the mixture is used for coating while UV curing is performed, so that not only can the modified graphene be induced to be oriented in parallel in the epoxy resin, but also the orientation state can be fixed in time to obtain a highly-oriented anti-corrosive coating.

(5) According to the present disclosure, the surface of the metal material is coated with an epoxy resin layer first, so that not only can the adhesion between the coating and the metal material be enhanced, but also the anti-corrosive coating has a better insulating property, thereby obtaining a long-lasting anti-corrosive coating.

### BRIEF DESCRIPTION OF THE DRAWINGS

FIG. 1 is a Raman spectrogram of a modified graphene prepared in Example 1.

FIG. 2 is a transmission electron micrograph of the modified graphene prepared in Example 1.

FIG. 3 is an atomic force micrograph of the modified graphene prepared in Example 1.

FIG. 4 is an infrared spectrogram of graphene, calcein, and the modified graphene in Example 1.

FIG. 5 is a fluorescence spectrogram of the calcein and the modified graphene in Example 1.

FIG. 6 is a picture of modified graphene dispersions prepared in Example 1 and Comparative Example 1.

FIG. 7 is a cross-sectional SEM image of coatings prepared in Comparative Example 1, Example 1, and Example 2.

FIG. 8 is a graph showing the results for corrosion resistance tests of the coatings in Examples 1-2 and Comparative Example 1.

FIG. 9 is a Bode plot of the electrochemical impedance of the coating prepared in Example 1.

FIG. 10 is a Bode plot of the electrochemical impedance of the coating prepared in Example 2.

FIG. 11 is a Bode plot of the electrochemical impedance of the coating prepared in Comparative Example 1.

### DETAILED DESCRIPTION

The technical solutions of the present disclosure will be further described in detail with reference to the following specific examples. It should be understood that the following examples are merely exemplary illustration and explanation of the present disclosure and should not be construed as limiting the protection scope of the present disclosure. All techniques implemented based on the content described above of the present disclosure are encompassed within the protection scope of the present disclosure.

Unless otherwise stated, the starting materials and reagents used in the following examples are all commercially available products or can be prepared by using known methods.

### Example 1

(1) A graphite powder and calcein were first added to deionized water to prepare a graphite powder/calcein dispersion (concentrations: 50 mg/mL for the graphite powder and 1 mg/mL for the calcein), and the dispersion was treated for 15 min by using a high-shear dispersing emulsifier to obtain a uniformly mixed graphite aqueous dispersion.

(2) The dispersion described above was added to a microfluidizer and circulated for 15 times through a 300 μm nozzle at 20,000 psi to obtain a modified graphene dispersion.

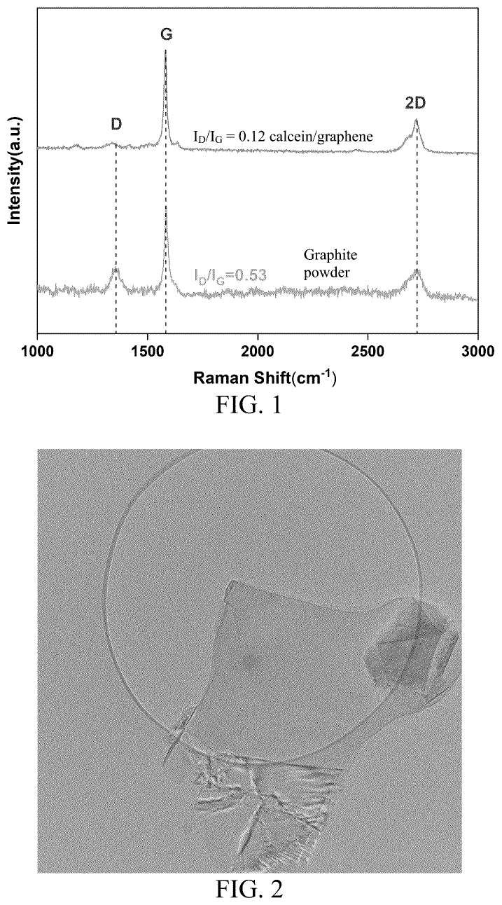

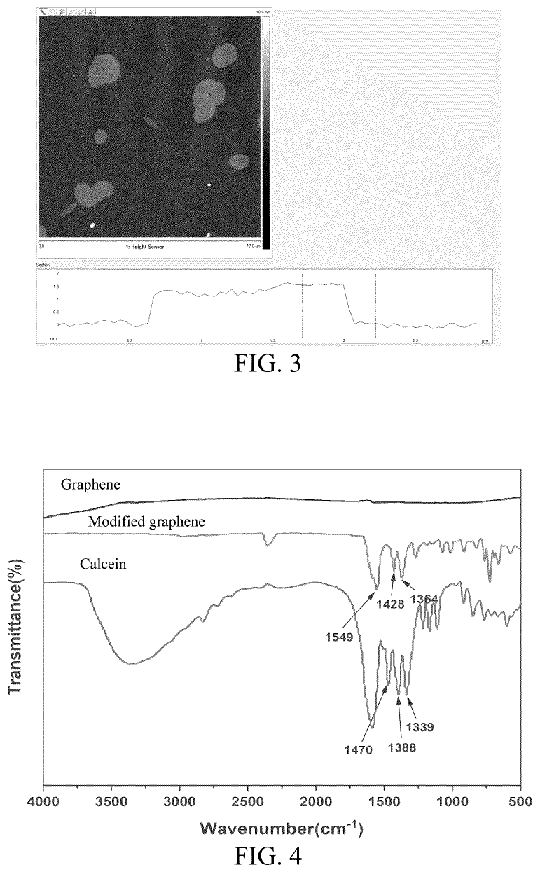

The Raman spectrogram of the modified graphene is shown in FIG. 1. The modified graphene (i.e., the calcein/graphene in FIG. 1) prepared by using the microfluidizer had a ratio of D peak to G peak of 0.12, and the 2D peak was a sharp singlet, so it could be determined that the number of layers of the prepared modified graphene was 5-7, and the modified graphene had a good stripping effect. The transmission electron micrograph of the modified graphene is shown in FIG. 2. The typical lamellar structure of the modified graphene could be clearly seen in FIG. 2, and the modified graphene had a wrinkling phenomenon.

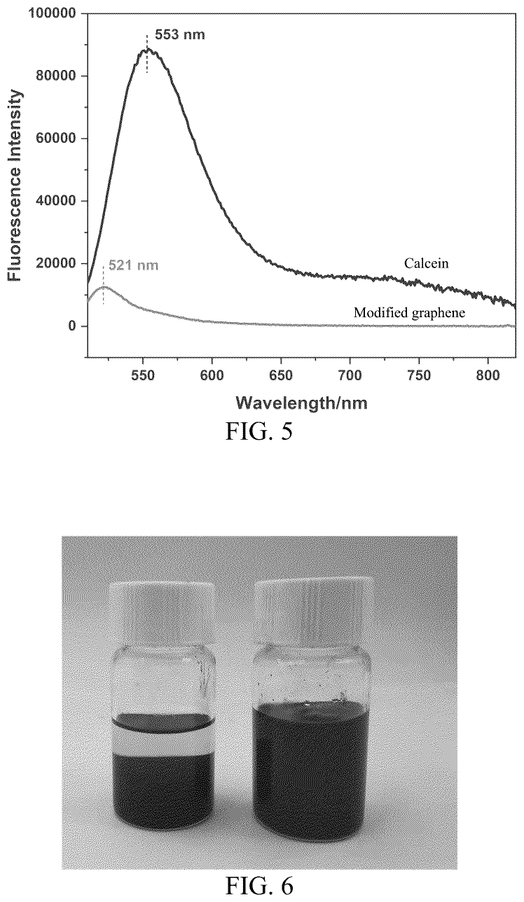

FIG. 4 is an infrared spectrogram of graphene, calcein, and the modified graphene. It could be seen that there was no significant characteristic peak in the spectrum of the graphene, the characteristic peaks in the spectrum of the modified graphene were mainly from the calcein, and the characteristic peaks in the spectrum of the modified graphene were significantly blue-shifted. Thus, the surface of the modified graphene contained the calcein. FIG. 5 is a fluorescence spectrogram of calcein and the modified graphene. It could be seen that a characteristic fluorescence peak was shown in the spectrum of the calcein after excitation, and this absorption peak was blue-shifted and had a greatly reduced peak density in the spectrum of the modified graphene, which indicated that there was a π-π interaction between the calcein and the graphene.

The photograph of the appearance of the modified graphene dispersion is shown on the right in FIG. 6. It could be seen that the modified graphene showed good dispersibility and excellent stability in the dispersion.

(3) The modified graphene aqueous dispersion was mixed with a mixture of bisphenol A epoxy resin and diphenyl(4-(phenylthio)phenyl)sulfonium hexafluoroantimonate (a mass ratio of the modified graphene to the mixture: 20:1, referred to as bisphenol A epoxy resin mixture), the resulting mixture was left to stand and subjected to phase separation, an aqueous phase was removed, and then water was further removed by rotary evaporation to obtain a modified graphene/epoxy resin mixture, in which the modified graphene had a mass fraction of 0.5%.

(4) The surface of a steel sheet was coated with a layer of bisphenol A epoxy resin mixture in advance, and then with a graphene/bisphenol A epoxy resin mixture by using a spin coater at 3000 rpm, and UV curing was performed for 120 s in the spin coating process to obtain an anti-corrosive coating.

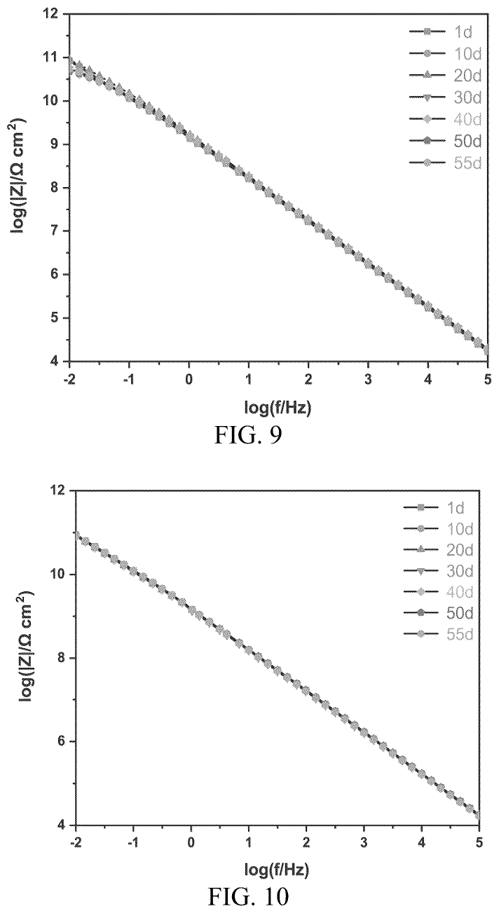

The Bode plot of the electrochemical impedance spectrum of the prepared coating is shown in FIG. 9. It could be seen that the coating had an impedance value reduced from 8.5×10¹⁰ Ω·cm² to 5.4×10¹⁰ Ω·cm² after being soaked for 55 days, which indicated that the coating was subjected to slight corrosion in the soaking period.

### Example 2

(1) A graphite powder and calcein were first added to deionized water to prepare a graphite powder/calcein dispersion (concentrations: 50 mg/mL for the graphite powder and 1 mg/mL for the calcein), and the dispersion was treated for 15 min by using a high-shear dispersing emulsifier to obtain a uniformly mixed graphite aqueous dispersion.

(2) The dispersion described above was added to a microfluidizer and circulated for 15 times through a 300 μm nozzle at 20,000 psi to obtain a modified graphene dispersion.

(3) The modified graphene aqueous dispersion was mixed with a mixture of bisphenol A epoxy resin and diphenyl(4-(phenylthio)phenyl)sulfonium hexafluoroantimonate (a mass ratio of the modified graphene to the mixture: 20:1), the resulting mixture was left to stand and subjected to phase separation, an aqueous phase was removed, and then water was further removed by rotary evaporation to obtain a modified graphene/epoxy resin mixture, in which the modified graphene had a mass fraction of 1%.

(4) The surface of a steel sheet was coated with a layer of bisphenol A epoxy resin mixture in advance, and then with a graphene/bisphenol A epoxy resin mixture by using a spin coater at 3000 rpm, and UV curing was performed for 120 s in the spin coating process to obtain an anti-corrosive coating.

The Bode plot of the electrochemical impedance spectrum of the prepared coating is shown in FIG. 10. It could be seen that the coating had an impedance value reduced from 8.96×10¹⁰ Ω·cm² to 8.45×10¹⁰ Ω·cm² after being soaked for 55 days, and the reduction speed of the impedance value was greatly reduced, which indicated that the coating was subjected to relatively slight corrosion in the soaking period.

### Example 3

(1) A graphite powder and calcein were first added to deionized water to prepare a graphite powder/calcein dispersion (concentrations: 50 mg/mL for the graphite powder and 4 mg/mL for the calcein), and the dispersion was subjected to ultrasonic dispersion for 30 min to obtain a uniformly mixed graphite aqueous dispersion.

(2) The dispersion described above was added to a microfluidizer and circulated for 30 times through a 200 μm nozzle at 10,000 psi to obtain a modified graphene dispersion.

(3) The modified graphene aqueous dispersion was mixed with a mixture of bisphenol A epoxy resin and diphenyl(4-(phenylthio)phenyl)sulfonium hexafluoroantimonate (a mass ratio of the modified graphene to the mixture: 20:1), the resulting mixture was left to stand and subjected to phase separation, an aqueous phase was removed, and then water was further removed by rotary evaporation to obtain a modified graphene/epoxy resin mixture, in which the modified graphene had a mass fraction of 1%.

(4) The surface of a steel sheet was coated with a layer of bisphenol A epoxy resin in advance, and then with a graphene/bisphenol A epoxy resin mixture by using a spin coater at 5000 rpm, and UV curing was performed for 200 s in the spin coating process to obtain an anti-corrosive coating.

### Example 4

(1) Natural flake graphite and calcein were added to water to prepare a natural flake graphite/calcein dispersion (concentrations: 50 mg/mL for the natural flake graphite and 8 mg/mL for the calcein), and the dispersion was stirred until a uniform system was obtained to obtain a natural flake graphite dispersion.

(2) The dispersion described above was added to a microfluidizer and circulated for 20 times through a 300 μm nozzle at a pressure of 3000 psi to obtain a modified graphene dispersion.

(3) The modified graphene aqueous dispersion was mixed with a mixture of bisphenol A epoxy resin and diphenyl(4-(phenylthio)phenyl)sulfonium hexafluoroantimonate (a mass ratio of the modified graphene to the mixture: 30:1), the resulting mixture was left to stand and subjected to phase separation, an aqueous phase was removed, and then water was further removed by rotary evaporation to obtain a modified graphene/epoxy resin mixture, in which the modified graphene had a mass fraction of 0.5%.

(4) The surface of a steel sheet was coated with a layer of bisphenol A epoxy resin in advance, and then with a graphene/bisphenol A epoxy resin mixture by using a spin coater at 3000 rpm, and UV curing was performed for 200 s in the spin coating process to obtain an anti-corrosive coating.

### Example 5

(1) Natural flake graphite and calcein were first added to deionized water to prepare a natural flake graphite/calcein dispersion (concentrations: 50 mg/mL for the natural flake graphite and 8 mg/mL for the calcein), and the dispersion was treated for 30 min by using a high-shear dispersing emulsifier to obtain a uniformly mixed natural flake graphite aqueous dispersion.

(2) The dispersion described above was added to a microfluidizer and circulated for 10 times through a 400 μm nozzle at 20,000 psi to obtain a modified graphene dispersion.

(3) The modified graphene aqueous dispersion was mixed with a mixture of hydrogenated bisphenol A epoxy resin and diphenyl(4-(phenylthio)phenyl)sulfonium hexafluoroantimonate (a mass ratio of the modified graphene to the mixture: 30:1), the resulting mixture was left to stand and subjected to phase separation, an aqueous phase was removed, and then water was further removed by rotary evaporation to obtain a modified graphene/epoxy resin mixture, in which the modified graphene had a mass fraction of 0.5%.

(4) The surface of a steel sheet was coated with a layer of hydrogenated bisphenol A epoxy resin in advance, and then with a graphene/bisphenol A epoxy resin mixture by using a spin coater at 5000 rpm, and UV curing was performed for 300 s in the spin coating process to obtain an anti-corrosive coating.

### Comparative Example 1

Comparative Example 1 was prepared in the same manner as Example 1 except that: for Comparative Example 1, in step (3), bisphenol A epoxy resin and diphenyl(4-(phenylthio)phenyl)sulfonium hexafluoroantimonate (mass ratio: 20:1) were mixed to prepare an epoxy resin coating.

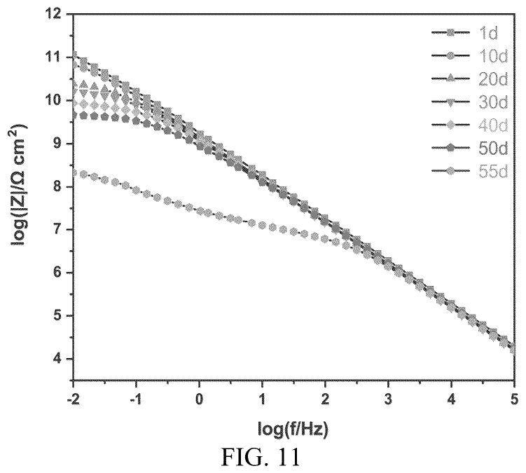

The Bode plot of the electrochemical impedance spectrum of the prepared coating is shown in FIG. 11. It could be seen that the coating had an impedance value reduced sharply from 1.2×10¹¹ Ω·cm² to 2.1×10⁸ Ω·cm² after being soaked for 55 days, and the reduction range of the impedance value was increased, which indicated that a corrosive medium completely permeated the coating to reach the surface of the steel sheet, resulting in severe corrosion.

Table 1 shows the number of layers, lateral dimensions, and conductivity of the modified graphene sheets in Examples 1-5.

The number of layers of the modified graphene sheets was determined by using an atomic force microscope.

The lateral dimensions of the modified graphene sheets were determined by using a transmission electron microscope.

The conductivity of the modified graphene was determined by using a four-probe method.

TABLE 1

| | | | | Product property | | |
|---|---|---|---|---|---|---|
| | Reaction condition | | | Number of | | |
| | Concentration | Concentration | Number of | layers of | Lateral | |
| | of modifier | of graphite | times for | graphene | dimension | Conductivity |
| | (mg/mL) | (mg/mL) | circulation | sheet (layer) | (μm) | (Ω/m) |
| Example 1 | 1 | 50 | 15 | 5-7 | 2-4 | 18864 |
| Example 2 | 2 | 50 | 15 | 6-8 | 4-5 | 13041 |
| Example 3 | 4 | 50 | 30 | 4-5 | 3-5 | 21777 |
| Example 4 | 8 | 50 | 20 | 3-5 | 3-5 | 24118 |
| Example 5 | 12 | 50 | 10 | 6-8 | 4-6 | 26375 |

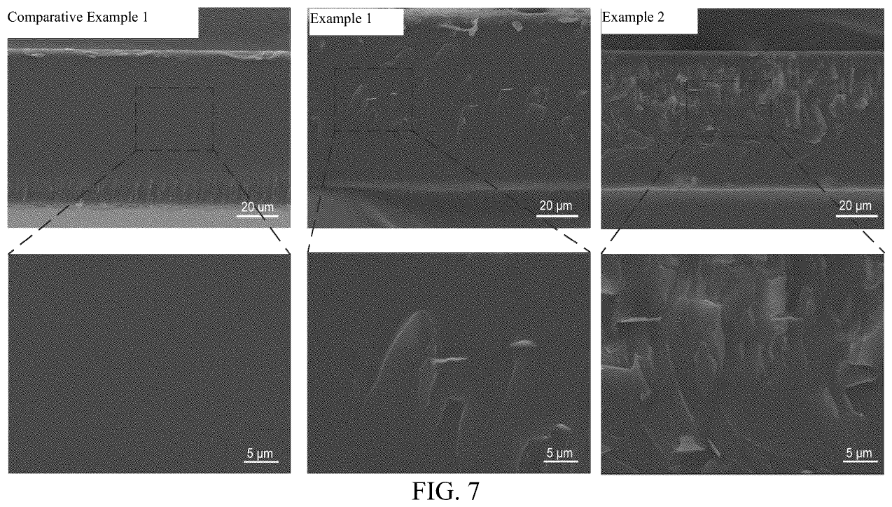

FIG. 7 is a cross-sectional SEM image of coatings prepared in Comparative Example 1, Example 1, and Example 2. As can be seen in FIG. 7, the thickness of these three coatings was about 70 μm. After the modified graphene was added to the epoxy resin, the cross section of the coating was rougher, and the fracture cracks were ridge-shaped and groove-shaped stripes, which showed nonlinear crack growth, indicating a good physical interaction between the modified graphene and the epoxy resin. In addition, the graphene sheets in the coating were in an orientation state of parallel alignment, and when the content of the modified graphene reached 1% (Example 2), a large number of graphene sheets arranged in parallel could be seen on the cross section of the coating, and these graphene sheets were not bridged with each other. This suggested that graphene could be oriented through centrifugal force generated by spin coating. In one aspect, the orientation is favorable for improving the barrier effect of the coating and increasing the number of invasion paths of corrosive media such as H₂O, O₂, and Cl⁻ to form a “labyrinth” effect; in another aspect, it can effectively prevent graphene from being bridged with graphene to form a conductive path. In addition, the surface of the steel sheet was coated with an epoxy resin layer and then with a modified graphene/epoxy resin layer, so that the double-layer structure design further avoided the electrochemical corrosion caused by direct contact of graphene with the surface of the steel sheet.

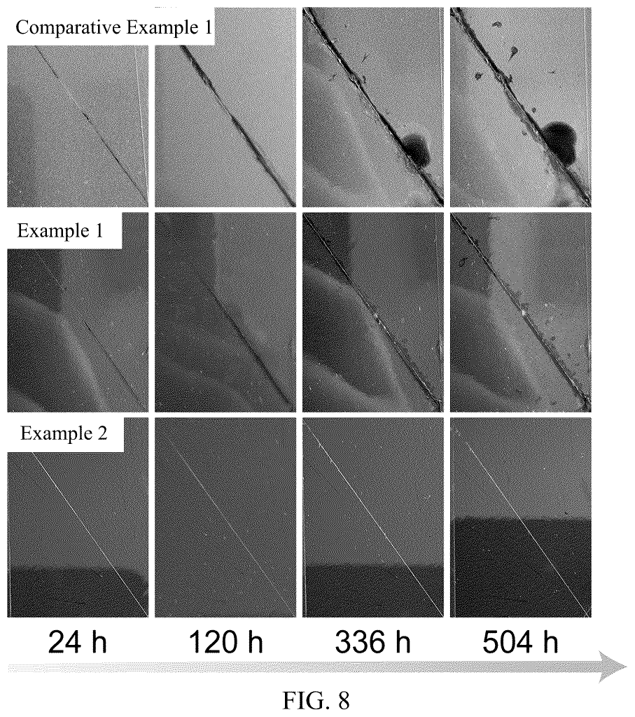

The coatings in Examples 1-2 and Comparative Example 1 were subjected to a corrosion resistance test, and the corrosion resistance of the damaged coating was analyzed by a salt spray test using a salt spray tester, with a 5.0 wt % NaCl solution sprayed continuously on the sample at 35° C., with the sample tilted at an angle of 20°. The test results are shown in FIG. 8. It could be clearly seen that a large amount of rust was produced at the scratch of the coating in Comparative Example 1 after 504 h of testing, and the rust at the scratch had a tendency to expand further inward. The coating in Example 1 was also subject to a certain degree of corrosion at the scratch, but the corrosion was slighter than that of the coating in Comparative Example 1, showing better corrosion resistance, in addition, the expansion of the corrosion was inhibited to a certain extent. The coating in Example 2, however, did not exhibit significant corrosion throughout the soaking cycle. This result can be attributed to the combined action of the calcein and the orientation-modified graphene. The corrosion inhibition effect of the calcein and the oriented graphene maximally extends the permeation paths of corrosive media, avoids graphene bridging, and inhibits the electrochemical corrosion promotion of graphene.

The embodiments of the present disclosure have been described above. However, the present disclosure is not limited to the embodiments described above. Any modification, equivalent replacement, improvement, and the like made without departing from the spirit and principle of the present disclosure shall fall within the protection scope of the present disclosure.

1. A preparation method for an anti-corrosive coating, comprising the following steps:
(1) dispersing graphite and a modifier in water to prepare a pretreated graphite dispersion;
(2) subjecting the pretreated graphite dispersion obtained in step (1) to stripping and modification to prepare a modified graphene dispersion;
(3a) mixing the modified graphene dispersion obtained in step (2) with epoxy resin and a cationic photoinitiator, standing, performing phase separation, removing an aqueous phase, further deeply removing water to obtain a graphene/epoxy resin mixture, and curing the obtained mixture to prepare the anti-corrosive coating.

2. The method of claim 1, comprising step (3b): mixing the modified graphene dispersion obtained in step (2) with epoxy resin and a cationic photoinitiator, coating the surface of a metal material with the obtained mixture, standing, performing phase separation, removing an aqueous phase, further deeply removing water to obtain a graphene/epoxy resin mixture, and performing curing to prepare the anti-corrosive coating, wherein
preferably, the method comprises step (3c): mixing the modified graphene dispersion obtained in step (2) with epoxy resin and a cationic photoinitiator, standing, performing phase separation, removing an aqueous phase, further deeply removing water to obtain a graphene/epoxy resin mixture, coating the surface of a metal material with an epoxy resin layer, then coating the surface of the epoxy resin layer with the mixture, and performing curing to prepare the anti-corrosive coating.

3. The method of claim 1, wherein in step (1), the modifier is calcein; the calcein has a structural formula shown as follows:

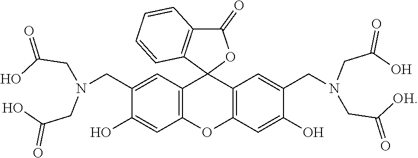 [SMILES: O=C(O)CN(CC(=O)O)Cc1cc2c(cc1O)Oc1cc(O)c(CN(CC(=O)O)CC(=O)O)cc1C21OC(=O)c2ccccc21]

4. The method of claim 1, wherein in step (1), the modifier is at a concentration of 1-20 mg/mL.

5. The method of claim 1, wherein in step (1), a starting material of the graphite is selected from at least one of natural flake graphite, expanded graphite, and graphite powder,
preferably, in step (1), graphite in the pretreated graphite dispersion is at a concentration of 1-60 mg/mL.

6. The method of claim 1, wherein in step (2), the stripping and modification are performed by using a microfluidizer.

7. The method of claim 1, wherein the epoxy resin is one of bisphenol A epoxy resin, hydrogenated bisphenol A epoxy resin, bisphenol F epoxy resin, bisphenol S epoxy resin, glycidyl ether epoxy resin, cycloaliphatic epoxy resin, silicone-modified epoxy resin, and polyurethane epoxy resin,
preferably, the cationic photoinitiator is one of an aryldiazonium salt, a diaryliodonium salt, a triarylsulfonium salt, and an arylferrocenium salt,
preferably, the epoxy resin and the cationic photoinitiator are in a mass ratio of 10-50:1.

8. The method of claim 1, wherein modified graphene in the modified graphene dispersion has a mass of 0.1%-2% of the total mass of the epoxy resin and the cationic photoinitiator,
the curing is UV curing, and the curing is performed for 50-300 s.

9. An anti-corrosive coating prepared by the method of claim 1.

10. The coating of claim 9, wherein the anti-corrosive coating has an impedance modulus of 1.0×10¹¹ Ω·cm²-8.5×10¹² Ω·cm² after being soaked in a 3.5 wt % NaCl solution for 55 days.
